(19) United States
(12) Patent Application Publication
(10) Pub. No.: US 2026/0350351 A1
(43) Pub. Date: Nov. 5, 2026

(54) IMAGE AND VIDEO COMPRESSION USING LEARNED DICTIONARY OF IMPLICIT NEURAL REPRESENTATIONS

(71) Applicant: INTERDIGITAL CE PATENT HOLDINGS, SAS, Paris (FR)

(72) Inventors: Alexandre SANOU, Clans (FR); Muhammet BALCILAR, Betton (FR); Bharath Bhushan DAMODARAN, Vannes (FR); Pierre HELLIER, Thorigne-Fouillard (FR)

(21) Appl. No.: 19/119,961

(22) PCT Filed: Sep. 28, 2023
(86) PCT No.: PCT/EP2023/076981

§ 371 Date: Apr. 10, 2025

(30) Foreign Application Priority Data
Oct. 11, 2022 (EP) 22306530.1

(51) Int. Cl. G06N 3/045; G06N 3/042; G06T 7/10

(52) U.S. Cl. CPC G06N 3/045; G06N 3/042; G06T 7/10; G06T 2207/10016

(57) ABSTRACT

Compression and decompression of video images is accomplished with improved Implicit Neural Representation (INR) methods of compression. Specifically, the representation is learned locally for a smaller image region, and the spatio-temporal redundancy is removed by reusing a large fraction of the representation. In one embodiment, the local INR corresponding to a partition of the image/video is computed for each part of the partition. A large fraction of the representation in terms of weights of the neural network is reused by having each representation decomposed into two parts: the head (containing preferably most of the weights), and the tail (a lightweight network designed to adapt the head to a particular image patch). In another embodiment, the large fraction of the representation is learned over a large collection of image patches to obtain a dictionary, known at both encoding and decoding sides, to reduce amount of data transmitted.

### CROSS REFERENCE TO RELATED APPLICATION

This application claims the benefit of European Application Serial No. 22306530.1, filed Oct. 11, 2022, which is incorporated by reference herein in its entirety.

### TECHNICAL FIELD

At least one of the present embodiments generally relates to a method or an apparatus for compression of images and videos using Neural Network based tools.

### BACKGROUND

Compared to classical approaches used in standardization, Machine Learning (ML) has emerged as a new tool to disrupt compression. The main idea is to learn the entire compression chain, including content description, quantization, entropy coding and descriptor decompression.

### SUMMARY

At least one of the present embodiments generally relates to a method or an apparatus in the context of the compression of images and videos using novel Neural Network (NN)-based tools. In particular, one objective of the described embodiments is improving Implicit Neural Representation (INR) methods for compression. Specifically, the representation is learned locally (for a smaller image region), and the spatio-temporal redundancy is removed by reusing a large fraction of the representation. The local INR would be a better fit in terms of rate-distortion.

According to a first aspect, there is provided a method. The method comprises steps for partitioning at least a portion of a video image into patches; determining at least one head network from global information of the at least portion of the video image; determining a plurality of tail networks from said patches of the at least portion of the video image; determining weights corresponding to the head network; optimizing weights of tail layers by minimizing an implicit neural representation of said patches through learning weights of the at least one head network; and; encoding said weights of tail layers into video data.

According to a second aspect, there is provided a method. The method comprises steps for parsing video data for weights of a tail network for a patch of video data; reconstructing the patch of video data using said weights along with an optimized head network.

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

According to another general aspect of at least one embodiment, there is provided a non-transitory computer readable medium containing data content comprising instructions to perform any of the encoding or decoding methods.

### BRIEF DESCRIPTION OF THE DRAWINGS

FIG. 1 illustrates an example image parameterization.

FIG. 2 illustrates an example of implicit neural representation.

FIG. 3 illustrates an example of an image to fit with SIREN network and residual.

FIG. 4 illustrates an example of multi-patch learning.

FIG. 5 illustrates examples of a) ground truth patches b) patches fitted by a shared network and c) patches fine tuned one-by-one.

FIG. 6 illustrates another example of a) ground truth patches b) patches fitted by a shared network and c) patches fine tuned one-by-one.

FIG. 7 illustrates another example of a) ground truth patches b) patches fitted by a shared network and c) patches fine tuned one-by-one.

FIG. 8 illustrates another example of a) ground truth patches b) patches fitted by a shared network and c) patches fine tuned one-by-one.

FIG. 9 illustrates another example of a) ground truth patches b) patches fitted by a shared network and c) patches fine tuned one-by-one.

FIG. 10 illustrates another example of a) ground truth patches b) patches fitted by a shared network and c) patches fine tuned one-by-one.

FIG. 11 illustrates another example of a) ground truth patches b) patches fitted by a shared network and c) patches fine tuned one-by-one.

FIG. 12 illustrates another example of a) ground truth patches b) patches fitted by a shared network and c) patches fine tuned one-by-one.

FIG. 13 illustrates another example of a) ground truth patches b) patches fitted by a shared network and c) patches fine tuned one-by-one.

FIG. 14 illustrates another example of a) ground truth patches b) patches fitted by a shared network and c) patches fine tuned one-by-one.

FIG. 15 illustrates one embodiment of a method for encoding video using the described embodiments.

FIG. 16 illustrates one embodiment of a method for decoding video using the described embodiments.

FIG. 17 illustrates one embodiment of an apparatus for encoding or decoding using the described embodiments.

FIG. 18 illustrates a standard, generic video compression scheme.

FIG. 19 illustrates a standard, generic video decompression scheme.

FIG. 20 illustrates a processor-based system for encoding/decoding under the general described aspects.

### DETAILED DESCRIPTION

The context of the described embodiments is the compression of image/video content.

Among these tools, a new proposal has recently emerged, based on Implicit Neural Representation (INR). The main idea is to represent the image function. For a 2D image, this function maps 2D coordinates into signal RGB values. Once the function is overfitted using a neural network, transmitting the image amounts to transmitting the weights of the neural network. INR have been used for various signals including audio, and 3D point clouds.

Now, the performances of the INR for compression barely reach those of SOTA methods, even for the most recent methods. The described embodiments propose a contribution to improve the performance.

The described embodiments are concerned by improving state of the art INR methods for compression. Specifically, the representation is learned locally (for a smaller image region), and the spatio-temporal redundancy is removed by reusing a large fraction of the representation. Although we refer to a video image being partitioned into “patches”, the current aspects and embodiments are not limited to patches and could pertain to any non-regular partition or segmentation of an image.

The described embodiments are concerned with finding local INR, that would be a better fit in terms of rate-distortion. That amounts to having a partition (regular or irregular) of the image/video to be compressed, and computing a INR for each part of the partition. In order to leverage the spatio-temporal redundancy, a large fraction of the representation (in terms of weights of the neural network) shall be reused. More specifically, each representation is decomposed into two parts: the head (containing preferably most of the weights), and the tail (a lightweight network designed to adapt the head to a particular image patch). The described embodiments propose two approaches:
Either a large fraction of the representation is used across different parts of the image. We refer to this as the Multi-Patch learning. For a given image, one or several head network can be used. This collection of head networks can also be used temporally.
Or, this large fraction of the representation is learned over a large collection of image patches, we obtain a dictionary of head networks. Ince this dictionary is learned, it is known at the encoder and decoder side, hence no longer being a transmission cost.

Let us first recall some background and known techniques for the INR, that are necessary to understand the aspects and embodiments described herein.

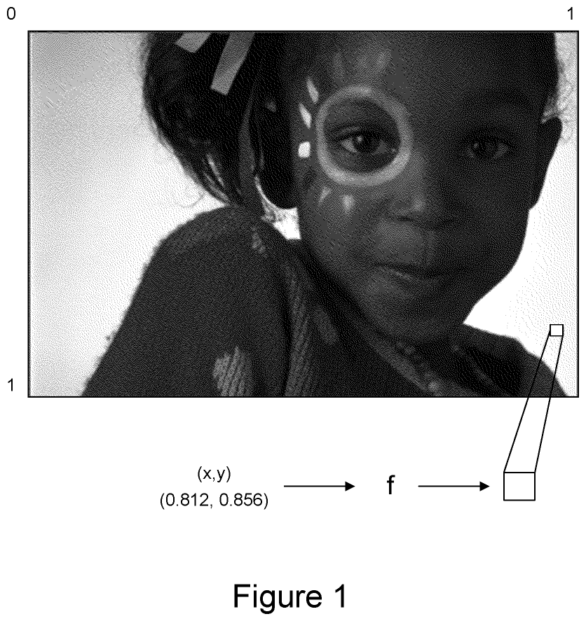

Implicit representation or coordinate based representation/parameterize a signal as a continuous function. For a 2D image, a pixel has a coordinate (x,y) describing its position in the image. The target of the continuous function is to get the RGB values of this pixel based on its coordinate. The FIG. 1 illustrates the coordinate-based representation.

As shown in FIG. 1, the Coordinate based representation each pixel has coordinate (x,y) such as x∈[0,1] and y∈[0,1], the function f is parametrized by a neural network to get RGB values. Implicit representation takes as input pixels coordinates and parametrize a function f by a neural network to get the corresponding RGB values.

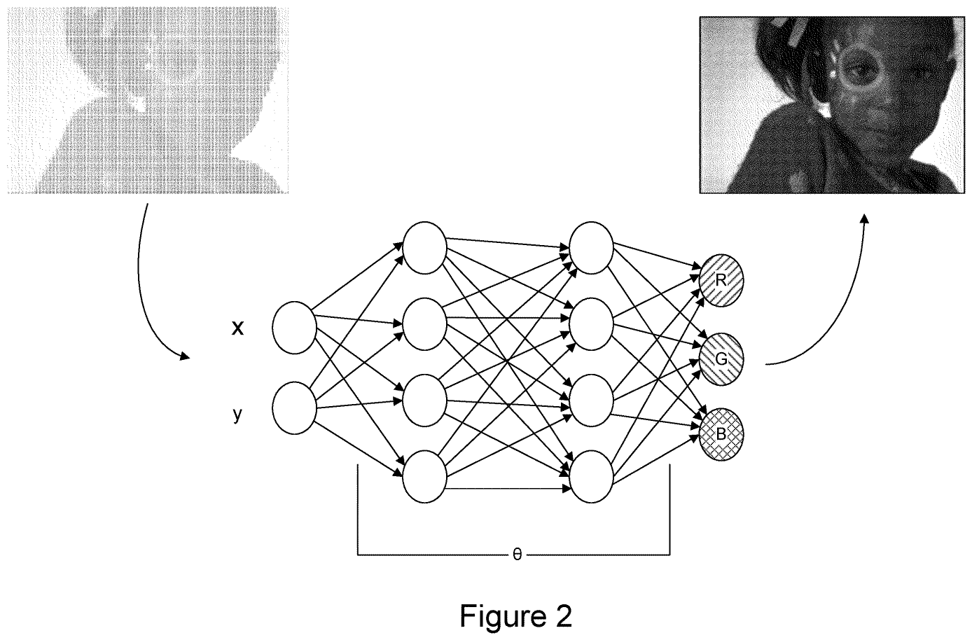

The exact mathematical formula of this function is unknown, a neural network is used to approximate this function, this is called implicit neural representations. FIG. 2 illustrates the implicit neural representation. FIG. 2 shows an Illustration of implicit neural representation: the neural network takes as input pixels coordinates and gives as output a RGB image. During the training the network will learn 6 which represents the weights of the neural network. Basically, the neural network is learning a function that matches pixels coordinates to their RGB values.

INRs have some benefits, first they are not coupled to a spatial resolution anymore. It means (an image is now independent of the number of pixels). INRs have “infinite resolution” because they can be sampled at arbitrary spatial resolutions. Second, as INRs are independent of spatial resolution, the memory requirement is scaled with the complexity of the underlying signal.

One main issue with the classical Multi Layer Perceptron (MPL) is that the obtained function is smooth. Hence, approximating the high-frequencies of he signal is difficult. To solve this, methods have proposed to use either sin activation functions, or Fourier embedding.

Let us consider I as our image to fit with a SIREN (sinunsoidal representation network) network. Our image can be represented by this following notation I[x,y] where (x,y) represent each pixel coordinate. The SIREN network will return the RGB values at each pixel location (x,y). We can represent the SIREN function ƒ_{θ}=R²→R³ with parameters θ, mapping pixel location to RGB values in the image I[x,y] i.e., ƒ_{θ}(x,y)=(r,g,b) The goal is to fit ƒ_{θ} to I[x,y] under some distortion measure, we use the mean squared error, resulting in the following optimization problem

$${min}_{θ} {\sum }_{x , y} {‖ {f}_{θ} ( x , y ) - I [ x , y ] ‖}_{2}^{2} \qquad ( 1 )$$

Where the sum is over all the pixels, ƒ_{θ}(x,y) is the predicted image and I[x,y] is the ground truth image. Function ƒ_{θ} is parametrized with a neural network composed of linear mapping and sin activation function and is learned classically with backpropagation of the reconstruction error.

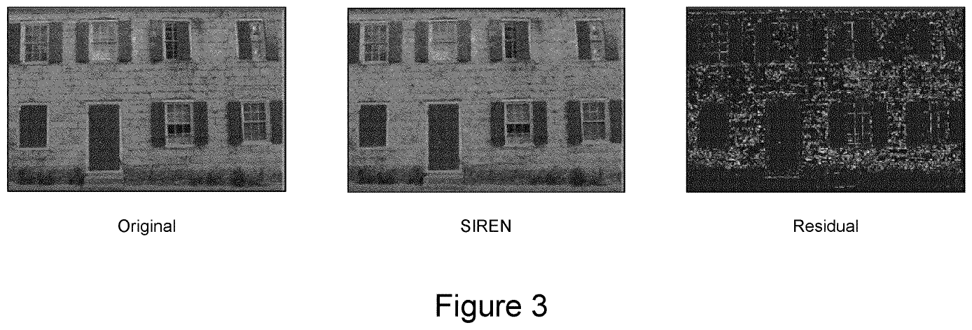

FIG. 3 provides an example of reconstruction that can be achieved with the Siren INR.

FIG. 3 shows SIREN fitted on image 1 from the kodak dataset. In the left we have the original image. In the middle we have our reconstructed image by SIREN. The residual image in the Right comes from the subtraction of the reconstructed image from the original image. The reconstructed image PSNR=22.45 dB for a model size at 0.6 bpp.

The Fourier method differs only in the fact that a layer is added after the image coordinates, mapping to a higher-dimensional space with known Fourier functions.

### Multi-Patch Learning

The INR optimizes the loss function in equation (1) on the entire image with single function ƒ_{θ} parameterized by the neural network. It captures the redundancy in the image implicitly, however it can reduce the redundancy better if it operates on the local patches.

Thus, we propose the multi-patch INR which operates on the local patching by composing a neural network of two functions ƒ_{θ}_{_{g}}, ƒ_{θ}_{ₗ}, where ƒ_{θ}_{_{g}} is labeled as the head and ƒ_{θ}_{ₗ} is labeled as tail. The head captures the global information, and its representation is shared among all the patches (or images, or frames in a video), whereas tail is adapted to the specific patch (or image, or frame). Let I be an image, and it is partitioned into M local regions, and each local region is labeled as patch. Thus, the image is represented as the collection of patches as I=[P₁, P₂, . . . , P_{M}].

The same decomposition applies to a set of frames, to account for the temporal redundancy. In the following, we refer to an image decomposition, but it should be understood that the method applies to a set of frames, without any loss of generality.

### Image Specific Multi-Patch INR

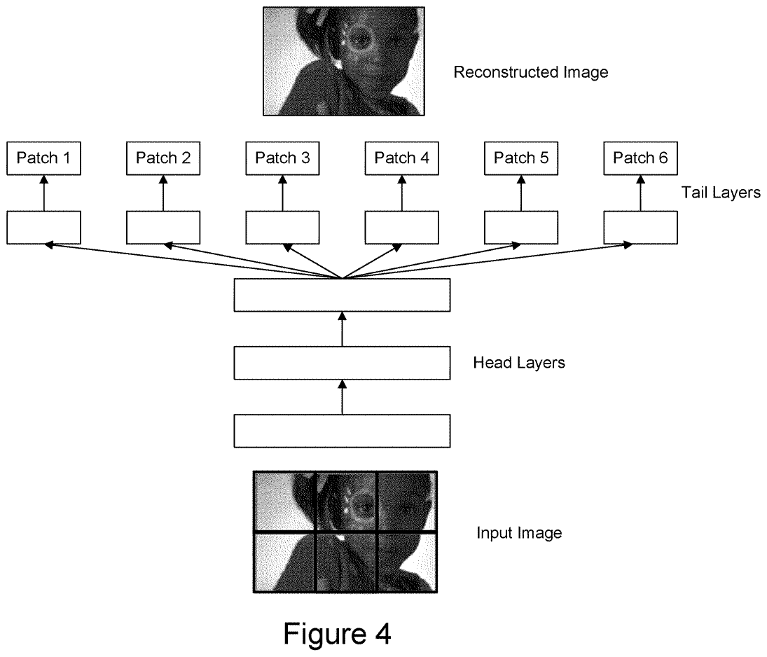

Let ƒ_{θ}=ƒ_{θ}_{ₗ} ᵢ, ƒ_{θ}_{_{g}}, i=1, . . . , M be the network composed of the head and tail network. For each image, there is one head and several tails. The weights of the head θ₉ is shared among all the patches and each local patch has it's own tail function to adapt to the local content. The loss function to minimize the Multi-patch INR can be written as

$${min}_{θ} {\sum }_{i , x , y} {‖ {f}_{θ} ( x , y ) - {P}_{i} [ x , y ] ‖}_{2}^{2} \qquad ( 2 )$$

where i varies over the patch's set index, and (x,y) are local image co-ordinates. The network architecture is depicted in FIG. 4.

FIG. 4 shows Multi-patch Learning. The input image is split in patches here 6 patches. All patches have the same shared network or shared head, and each patch has its own network. The tail network is composed of patch specific networks. The shared head will learn a global representation of all the patches and the tail network will adapt this global representation to each patch. The MPL network is trained in parallel on all the patches and the patches are merged to reconstruct the image.

The minimization of equation (2) is performed in two steps:
(1) The weights of the head layers and all the tail layers are learnt jointly.
(2) The weights of head layers are frozen, and only the weights of the tail layers are optimized to adapt the specific local content of each patch.

In this way, the first step ensures to capture the global information present in the image by the head layers, and second step ensures to adapt the local content of each patch. The weights of the loss function are optimized using gradient descent or stochastic gradient descent method. Once the weights are optimized, they are further encoded in the bit-stream using any entropy coder technique.

### Image Independent Multi-Patch INR

In the previous section, each image has its own specific head, whereas here the head is independent and common to all the images. The weights are of the head learnt over the large collection of patches. Let [P₁, P₂, . . . , P_{N}] be the large collection of diverse N patches. The head layers are optimized with respect to the following loss function, with ƒ_{θ}_{ₛ} composing a single function (network)

$${min}_{θ} {\sum }_{i , x , y} {‖ {f}_{{θ}_{g}} ( x , y ) - {P}_{i} [ x , y ] ‖}_{2}^{2} , i = 1 , 2 ... , N \qquad ( 3 )$$

Once the weights of the head network are trained, for any given image to be encoded, we partition image into local patches, and we add the tail networks on the top of the optimized head network (frozen) to adapt the local content of the patches and optimize the weights of the tail network. The weights of the tail network can also be forced to sparse by adding the L₁ regularization in the loss as in equation (4). As the head network is independent of the images, it is known by both encoding and decoding side, thus we need to only transmit the weights of the tail network.

$${min}_{{θ}_{l}} {\sum }_{i , x , y} {‖ {f}_{{θ}_{{l}_{i}}} \cdot {f}_{{\hat{θ}}_{g}} ( x , y ) - {P}_{i} [ x , y ] ‖}_{2}^{2} + λ {‖ {θ}_{{l}_{i}} ‖}_{1} \qquad ( 4 )$$

Without any loss of generality, this applied to a temporal encoding of a video sequence, where the head is learned on the first frame of the sequence, and used for the remaining frames.

### Dictionary Learning

Here the aim is to learn the collection of head layers. Let D=[d₁, d₂, . . . d_{K}] be the dictionary to be learnt, and each element dₖ in the dictionary is the weights of the head layers. Once we have this dictionary, for a given image we choose the optimal head layers from the D.

The dictionary D is learnt from the large collection of image patches in two ways

The patches are clustered into K clusters, and for each cluster the weights of the head layers are learnt. Thus, each cluster might represent images different information content. For the clustering we can use any existing clustering techniques. The clustering can be performed on the image domain (pixels), or it can be computed on the features extracted from the off the shelf deep neural networks

From the collection of the head layers in the description of image specific multi-patch INR, we cluster them to learn K elements of the dictionary

During the encoding, the selection of head (dictionary) can be performed in several ways:

In the first case, the selection of head layer can be performed by computing the distance between the image patch and cluster centers and the cluster center which has minimum distance is selected as the head layer. The distance could be mean squared error.

The head layer which has minimum loss between the reconstructed image and original image can be selected as the head layer

We train the classifier which takes the input as the patch and outputs the index of the head to be selected.

In the bit-stream, in addition to weights we also encode the index of the dictionary that is used as the head layer.

### Encoding the Weights

Once the weights are optimized as described in the sections on multi-patch INR, the weights are encoded in the bit-stream. To encode the weights, it can be done in the following ways
(1) The weights can be encoded in the half-precision (16 bit)
(2) The weights can be encoded with 8-bit quantization with maximum absolute normalization
(3) The weights can be encoded with explicit probability distribution by estimating the parameters of the distribution from the weights. For example, with gaussian distribution, mean and variance are estimated from the weights
(4) The weights can be encoded 8-bit quantization with maximum absolute normalization and border aware entropy model.
(5) The equation (2) and (4) can also include the entropy model, and thus weights will be minimized with entropy model, in this case the equation (2) becomes

$${min}_{θ} {\sum }_{i , x , y} {‖ {f}_{θ} ( x , y ) - {P}_{i} [ x , y ] ‖}_{2}^{2} + β \cdot p ( θ ) \qquad ( 5 )$$

and equation (4) becomes as

$${min}_{{θ}_{l}} {\sum }_{i , x , y} {‖ {f}_{{θ}_{{l}_{i}}} \cdot {f}_{{\hat{θ}}_{g}} ( x , y ) - {P}_{i} [ x , y ] ‖}_{2}^{2} + λ {‖ {θ}_{{l}_{i}} ‖}_{1} + β \cdot p ( {θ}_{l} ) . \qquad ( 6 )$$

During training, the uniform noise is added on the weights to approximate the quantization error during the test (encoding) time. During the encoding, the weights are quantized to nearest integer and encoded into the bit-stream by the learnt CDF of p(⋅)

### Results

### Multi-Patch INR Experiments on Kodak Dataset Images

Multi-patch INR experiments are done with the FOUREN network, the objective here is to reconstruct images with a small tail and send the weights of the tail to the receiver side. The head is already known by the encoder and the decoder. The objective is to find the best network architecture to reconstruct images with a tail at 0.68 bpp.

Our Multi-patch INR with FOUREN is implemented in PyTorch and we performed all experiments on a single Tesla M60 GPU with 8 GB RAM. We have two steps to train our model. First, we trained our network over all the patches. This will give us a global representation over all the patches. Then we fine-tuned each patch one by one in order to get better representation of each patch.

The technique used for the training is called freezing. In the context of neural networks, freezing a layer is about controlling the way the weights are updated. A frozen layer means that its weights cannot be modified further. In our case during the training, layers of the head are frozen. The tail has the same number of sub network equivalent to the number of patches. To train a specific patch we also freeze the others sub network. It means that only the weights of the current patch are updated.

In the following experiments the objective is to find the best architecture to send less information to the decoder. We will work with a tail size at 0.68 bpp and put all the network complexity in the head.

### Multi-Patch INR Applied to a Set of Patches

We choose 10 patches from some images of the kodak dataset. We reconstructed these patches using the shared network and the one-by-one fine tuning network. To train our networks we introduced some parameters: Patch size of 64 by 64 pixels, mapping size of 256. The network has been trained for 15K iterations with a learning rate of 2⁻⁴.

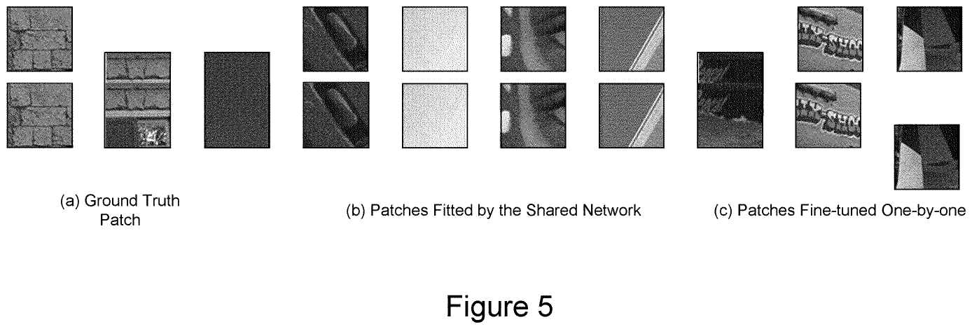

FIG. 5 shows Ground truth patches: 10 patches of size 64*64 px retrieved from some kodak dataset images. (a): all original patches. (b): Patches fitted by the shared network, we trained our network with 20 head layers and 1 tail layer, with a layer width of 20 nodes and a learning rate of 2⁻⁴ for 15K iterations. (c): Patches fine-tuned one-by-one, we retrained our network for each patch with a learning rate of 0.5*2⁻⁴ for 0.5*15K iterations.

In FIG. 5 we can see that fitting patches with the same shared network introduces some artefacts in patches because the network is learning to reconstruct the patches at the same time with the same representation. Then we fine-tuned patch-by-patch we get better patches reconstruction because the weights of each tail will be again updated.

Table 1 shows more experiments results based on the network architecture. We have one tail layer at 0.68 bpp for each network. By varying the number of head layers, we can see some change on the network performance. When the head is too small or too big the network performance is low. We found that a head size around 40-45 bpp gives good PSNR average for the 10 patches. Our next step will be to apply this method to entire images from the kodak dataset.

TABLE 1
Network performance evaluated on our 10 previous patches for different network architectures. NL_head: number of head layers,
NL_Tail: number of tail layers, num_Layers: Total number of layers (head + tail), Head node: each head layer width, tail_node:
each tail layer width, mapping size: fourier feature mapping size, mean_PSNR: PSNR average of the shared network over all the patches, mean_PSNR_{—}
fine_tuned: PSNR average over all patches after fine tuning patch-by-patch, bpp_head: bpp of the head, bpp_tail: bpp of the tail.

| | | | | | | | Mean_PSNR_fine- | | |
|---|---|---|---|---|---|---|---|---|---|
| | | | | | | Mean_PSNR | tuned | bpp_head | bpp_tail |
| NL_head | NL_Tail | Num_Layers | Head_node | Tail_node | Mapping_size | (dB) | (dB) | (bpp) | (bpp) |
| 4 | 1 | 5 | 28 | 28 | 256 | 25.68 | 25.64 | 13.12 | 0.68 |
| 4 | 1 | 5 | 64 | 28 | 256 | 31.54 | 31.47 | 33.57 | 0.68 |
| 6 | 1 | 7 | 28 | 28 | 256 | 26.66 | 26.62 | 14.39 | 0.68 |
| 6 | 1 | 7 | 64 | 28 | 256 | 33.31 | 33.16 | 40.07 | 0.68 |
| 8 | 1 | 9 | 28 | 28 | 256 | 25.96 | 25.92 | 15.66 | 0.68 |
| 8 | 1 | 9 | 64 | 28 | 256 | 32.66 | 32.52 | 46.57 | 0.68 |
| 10 | 1 | 11 | 28 | 28 | 256 | 24.8 | 24.76 | 16.93 | 0.68 |
| 10 | 1 | 11 | 64 | 28 | 256 | 27.92 | 27.8 | 53.07 | 0.68 |

### Multi-Patch INR Applied to Full Images

Following the same idea of applying MPL to a set of patches, we will apply the same method to images. The image is divided in patches of the same size. Our experiments are made on three different patch size 64*64, 128*128, and 256*256. Our kodak dataset images have the same size of 768*512 pixels which gives 96 patches for 64 patch size, 24 patches for 128 patch size and 6 patches for 256 patch size. Theoretically the network will learn a global representation that match all the patches. We want to maintain the tail bbp smaller as possible, 0.68 bpp seems a good value for the tail. In these experiments we reconstructed our images by varying the head size to find the best architecture for images representation.

### Multi-Patch INR at Low Head Size

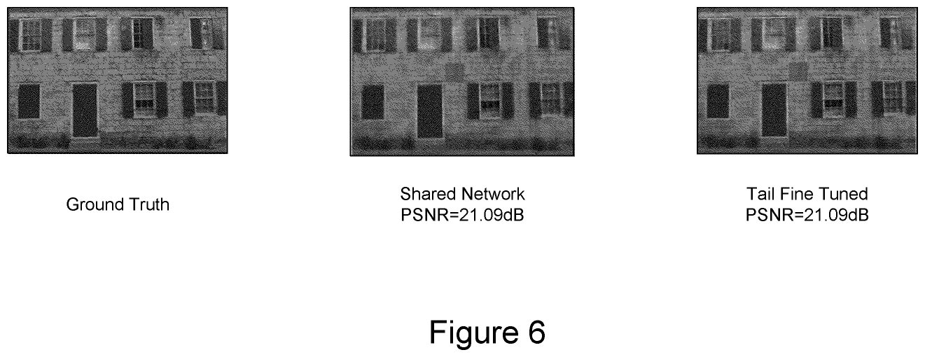

Our first MPL network is built on 64*64 patch size. This model has 10 head layers with 64 layer width and 1 tail layer with 28 layer width. The head size is 5.53 bpp and the tail size is 0.68 bpp. The Fourier features mapping size=256, we trained the network for 10 k iterations with a learning rate of of 24. The network gives us a reconstructed image from the shared network and the reconstructed image fine-tuned patch by patch. The results in FIGS. 6, 7 and 8 show that this network architecture is not performing well because the network learns over 96 patches, the network size is too small to handle it. PSNR values are below 30 dB, we need to need to increase the head size that means a larger patch size.

FIG. 6 shows MPL fitted on image 1 from the kodak dataset. The network head size at 5.53 bpp, tail size at 0.68 bpp. In the left we have the original image. In the middle we have our reconstructed image by the shared network. In the Right we have our reconstructed image by fine tuning the network patch by patch. The shared network reconstructed the image with a PSNR 21.09 dB. We fine-tuned the network patch by patch and we obtained PSNR 21.10 dB.

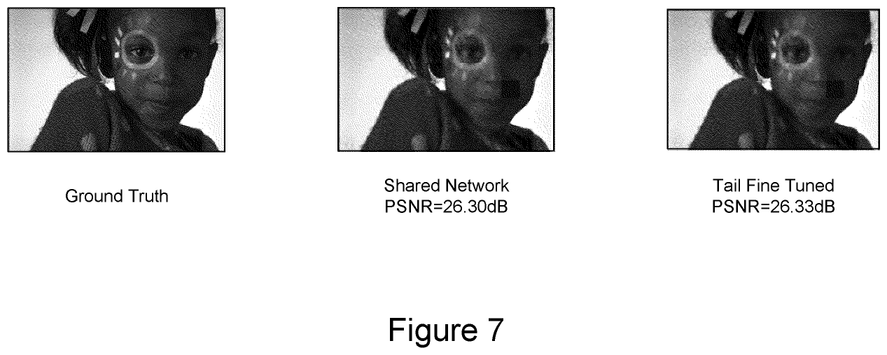

FIG. 7 shows MPL fitted on image 15 from the kodak dataset. The network head size at 5.53 bpp, tail size at 0.68 bpp. In the left we have the original image. In the middle we have our reconstructed image by the shared network. In the Right we have our reconstructed image by fine tuning the network patch by patch. The shared network reconstructed the image with a PSNR 26.30 dB. We fine-tuned the network patch by patch and we obtained PSNR 26.33 dB.

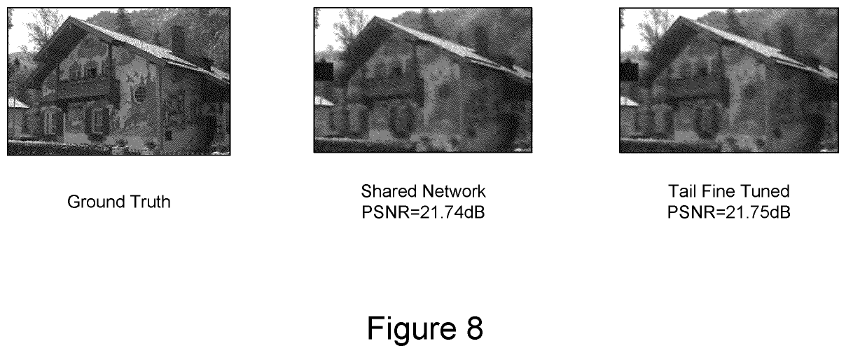

FIG. 8 shows MPL fitted on image 24 from the kodak dataset. The network head size at 5.53 bpp, tail size at 0.68 bpp. In the left we have the original image. In the middle we have our reconstructed image by the shared network. In the Right we have our reconstructed image by fine tuning the network patch by patch. The shared network reconstructed the image with a PSNR 21.74 dB. We fine-tuned the network patch by patch and we obtained PSNR 21.75 dB.

### Multi-Patch INR at Medium Head Size

Our second MPL network is built on 128*128 patch size. This model has 8 head layers with 160 layer width and 1 tail layer with 110 layer width. Now the head size is 20.70 bpp and the tail size is 0.65 bpp. The Fourier features mapping size=256, we trained the network for 10 k iterations with a learning rate of 2⁻⁴. From FIGS. 6.9, 6.10, 6.11 we can see that PSNR values are around 30 dB that is an acceptable quality reconstruction, we have just 24 patches and the head size is sufficient large.

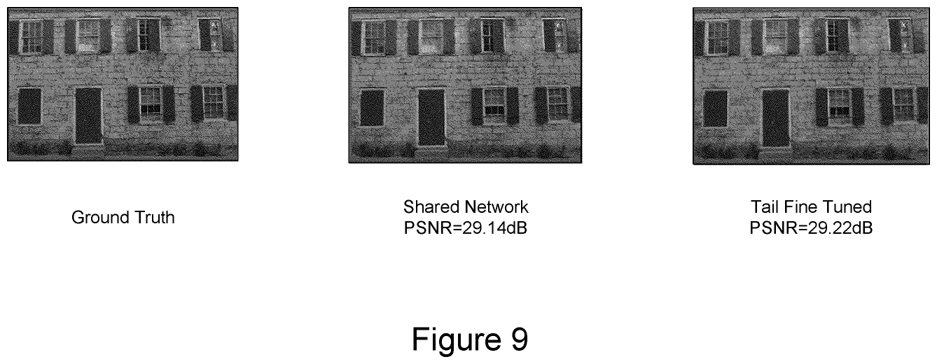

FIG. 9 shows MPL fitted on image 1 from the kodak dataset. The network head size at 20.70 bpp, tail size at 0.65 bpp. In the left we have the original image. In the middle we have our reconstructed image by the shared network. In the Right we have our reconstructed image by fine tuning the network patch by patch. The shared network reconstructed the image with a PSNR 29.14 dB. We fine-tuned the network patch by patch and we obtained PSNR 29.22 dB.

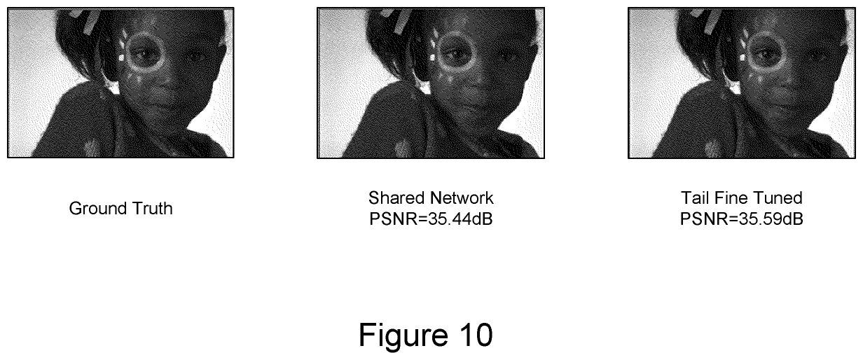

FIG. 10 shows MPL fitted on image 15 from the kodak dataset. The network head size at 20.70 bpp, tail size at 0.65 bpp. In the left we have the original image. In the middle we have our reconstructed image by the shared network. In the Right we have our reconstructed image by fine tuning the network patch by patch. The shared network reconstructed the image with a PSNR 35.44 dB. We fine-tuned the network patch by patch and we obtained PSNR 35.59 dB.

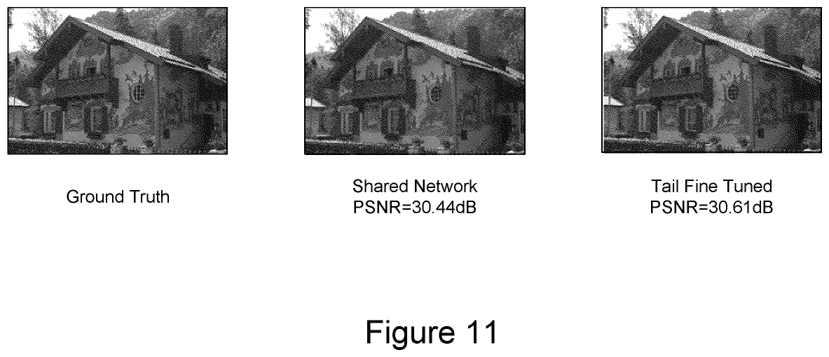

FIG. 11 shows MPL fitted on image 24 from the kodak dataset. The network head size at 20.70 bpp, tail size at 0.65 bpp. In the left we have the original image. In the middle we have our reconstructed image by the shared network. In the Right we have our reconstructed image by fine tuning the network patch by patch. The shared network reconstructed the image with a PSNR 30.44 dB. We fine-tuned the network patch by patch and we obtained PSNR 30.61 dB.

### Multi-Patch INR at High Head Size

With a high head size, we want to get a quasi-perfect reconstruction of images. The MPL network is built on 256*256 patch size. This model has 5 head layers with 512 layer width and 1 tail layer with 450 layer width. Now the head size is 104.29 bpp and the tail size is 0.66 bpp. The Fourier features mapping size=256, we trained the network for 10 k iterations with a learning rate of 2⁻⁴. The high head size gave us PSNR values around 40 dB which is a perfect reconstruction quality for images as it can be seen in FIGS. 6.12, 6.13 and 6.14.

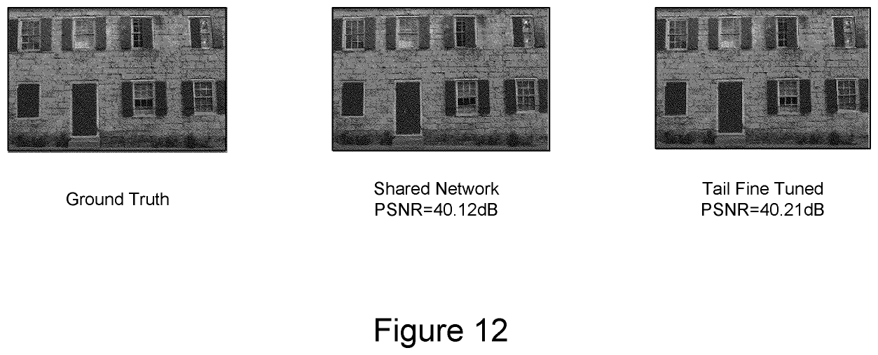

FIG. 12 shows MPL fitted on image 1 from the kodak dataset. The network head size at 104.29 bpp, tail size at 0.66 bpp. In the left we have the original image. In the middle we have our reconstructed image by the shared network. In the Right we have our reconstructed image by fine tuning the network patch by patch. The shared network reconstructed the image with a PSNR 40.12 dB. We fine-tuned the network patch by patch and we obtained PSNR 40.21 dB.

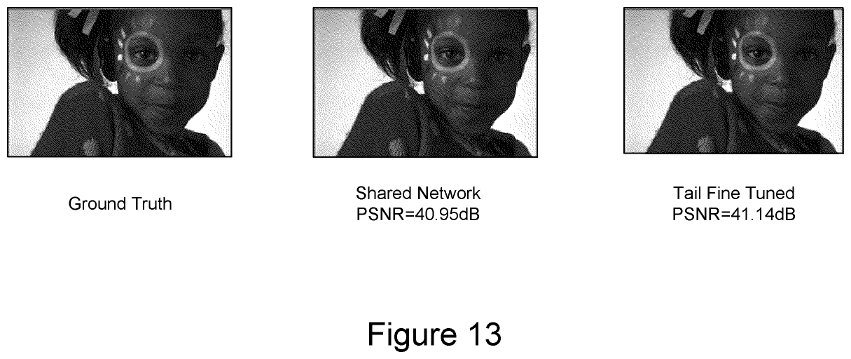

FIG. 13 shows MPL fitted on image 15 from the kodak dataset. The network head size at 104.29 bpp, tail size at 0.66 bpp. In the left we have the original image. In the middle we have our reconstructed image by the shared network. In the Right we have our reconstructed image by fine tuning the network patch by patch. The shared network reconstructed the image with a PSNR 40.95 dB. We fine-tuned the network patch by patch and we obtained PSNR 41.14 dB.

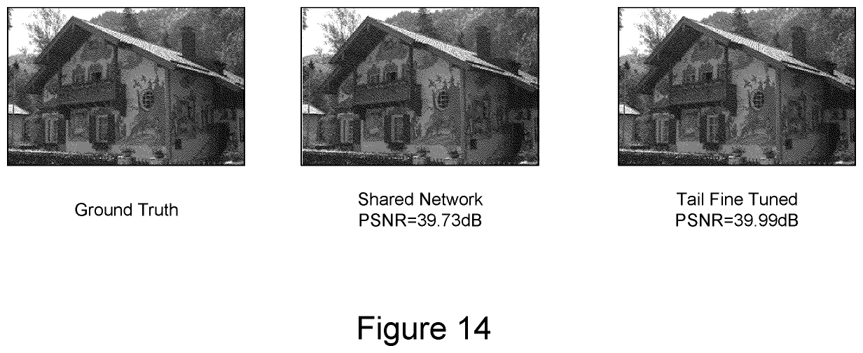

FIG. 14 shows MPL fitted on image 24 from the kodak dataset. The network head size at 104.29 bpp, tail size at 0.66 bpp. In the left we have the original image. In the middle we have our reconstructed image by the shared network. In the Right we have our reconstructed image by fine tuning the network patch by patch. The shared network reconstructed the image with a PSNR 39.73 dB. We fine-tuned the network patch by patch and we obtained PSNR 39.99 dB.

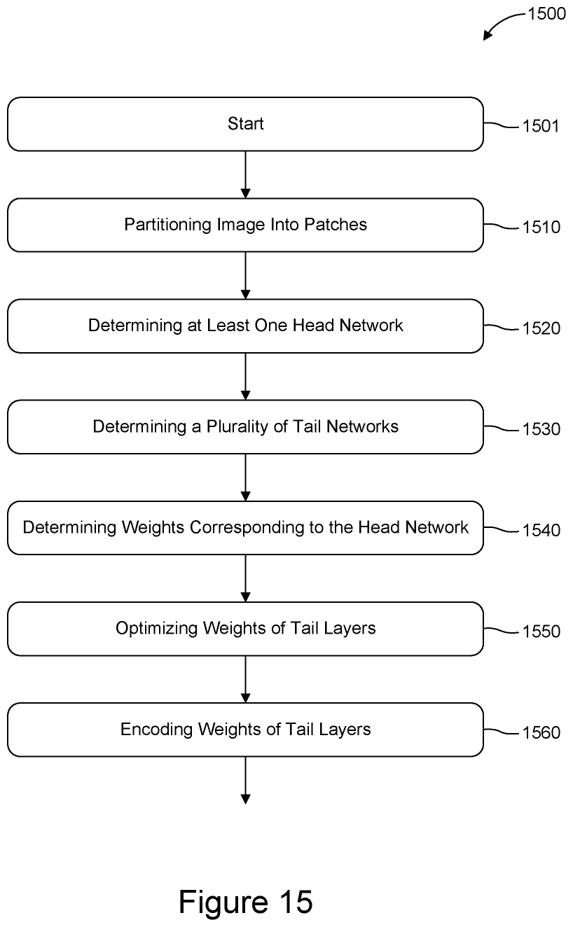

One embodiment of a method 1500 for encoding video data is shown in FIG. 15. The method commences at Start bock 1501 and proceeds to block 1510 for partitioning at least a portion of a video image into patches. Control proceeds from block 1510 to block 1520 for determining at least one head network from global information of the at least portion of the video image. Control proceeds from block 1520 to block 1530 for determining a plurality of tail networks from said patches of the at least portion of the video image. Control proceeds from block 1530 to block 1540 for determining weights corresponding to the head network. Control proceeds from block 1540 to block 1550 for optimizing weights of tail layers by minimizing an implicit neural representation of said patches through learning weights of the at least one head network. Control proceeds from block 1550 to block 1560 for encoding said weights of tail layers into video data.

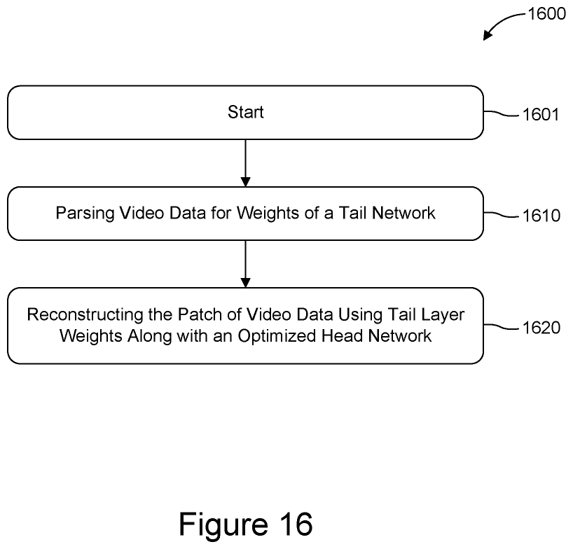

One embodiment of a method 1600 for decoding video data is shown in FIG. 16. The method commences at Start block 1601 and proceeds to block 1610 for parsing video data for weights of a tail network for a patch of video data. Control proceeds from block 1610 to block 1620 for reconstructing the patch of video data using said weights along with an optimized head network.

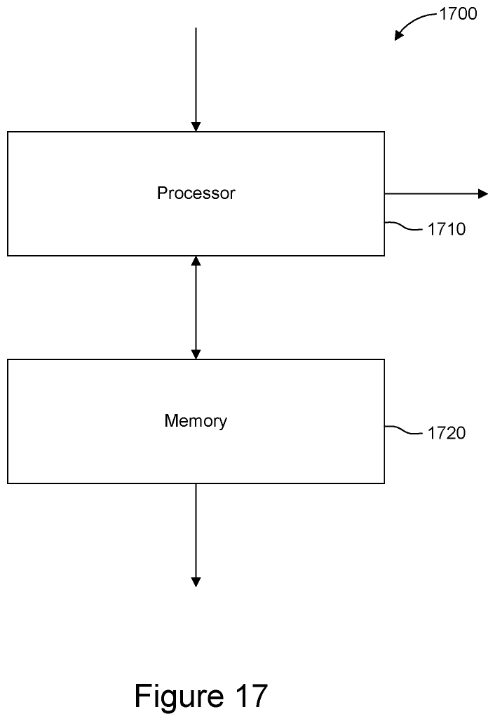

FIG. 17 shows one embodiment of an apparatus 1700 for compressing, encoding or decoding video using the aforementioned methods. The apparatus comprises Processor 1710 and can be interconnected to a memory 1720 through at least one port. Both Processor 1710 and memory 1720 can also have one or more additional interconnections to external connections.

Processor 1710 is also configured to either insert or receive information in a bitstream and, either compressing, encoding, or decoding using the aforementioned methods.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

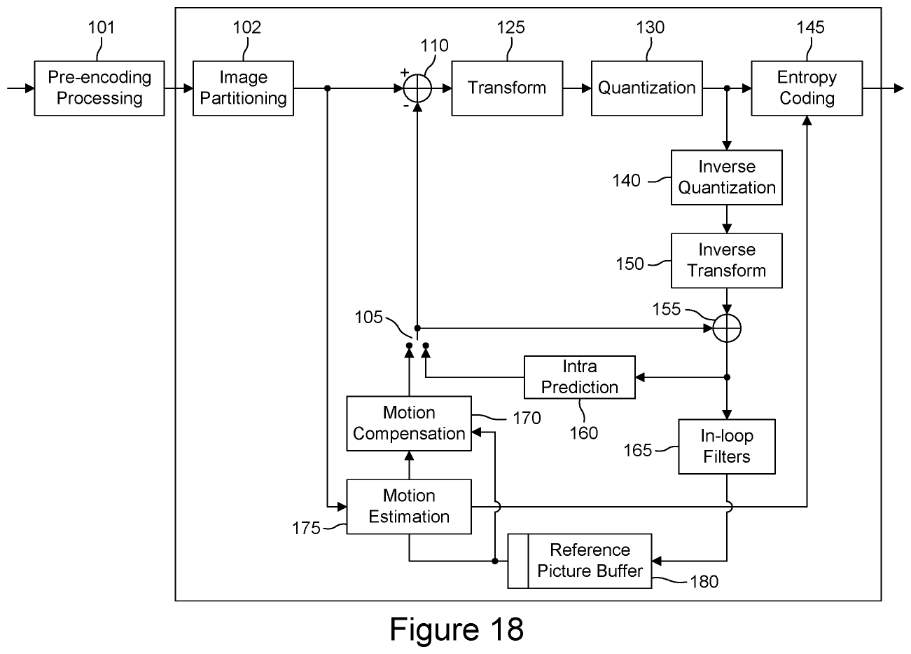

The aspects described and contemplated in this application can be implemented in many different forms. FIGS. 18, 19, and 20 provide some embodiments, but other embodiments are contemplated and the discussion of FIGS. 18, 19, and 20 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” or “reconstructed” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

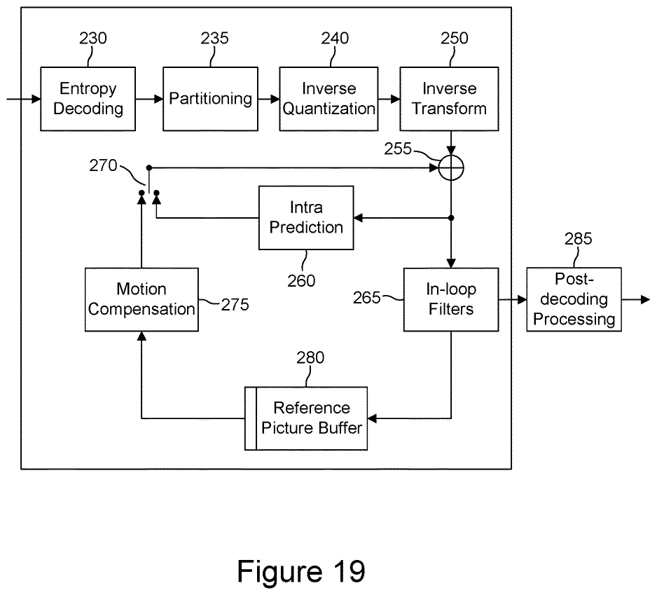

Various methods and other aspects described in this application can be used to modify modules, for example, the intra prediction, entropy coding, and/or decoding modules (160, 360, 145, 330), of a video encoder 100 and decoder 200 as shown in FIG. 18 and FIG. 19. Moreover, the present aspects are not limited to WC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 18 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 19 illustrates a block diagram of a video decoder 200. In the decoder 200, a bitstream is decoded by the decoder elements as described below. Video decoder 200 generally performs a decoding pass reciprocal to the encoding pass as described in FIG. 18. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

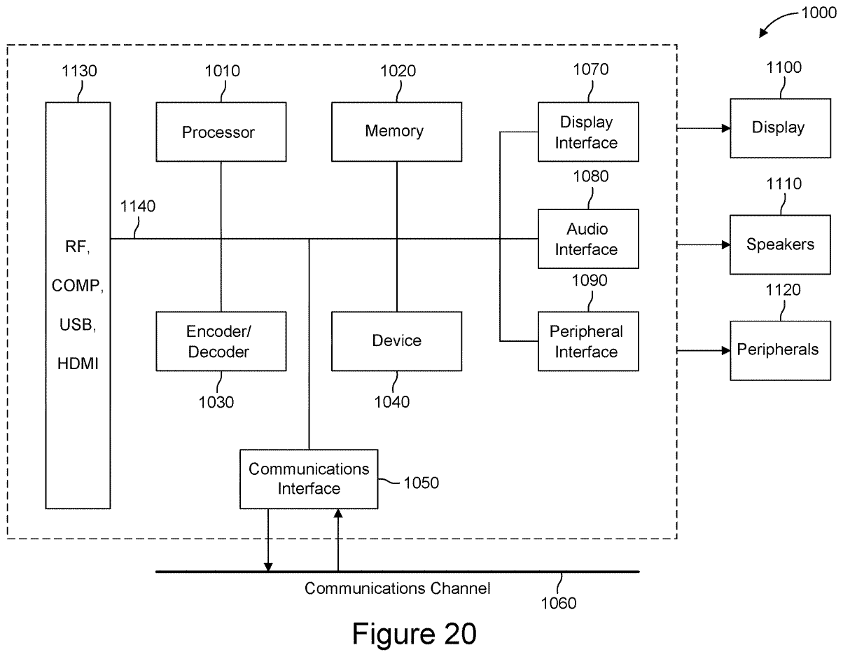

FIG. 20 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 20, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types.

At least one embodiment comprises encoding and decoding of video information using neural networks.

At least one embodiment comprises determining weights corresponding to a tail network for a video image.

At least one embodiment comprises using weights in conjunction with a head network for compression/decompression of video image.

At least one embodiment comprises building a dictionary of head layers for a neural network

At least one embodiment comprises clustering patches to learn head layer weights of each cluster, performed in the image domain, or on extracted features from deep neural networks.

At least one embodiment comprises a bitstream or signal that includes one or more of the described syntax elements, or variations thereof.

At least one embodiment comprises a bitstream or signal that includes syntax conveying information generated according to any of the embodiments described.

At least one embodiment comprises creating and/or transmitting and/or receiving and/or decoding according to any of the embodiments described.

At least one embodiment comprises parsing video data or a bitstream to determine operating point of a codec.

At least one embodiment comprises a method, process, apparatus, medium storing instructions, medium storing data, or signal according to any of the embodiments described.

At least one embodiment comprises inserting in the signaling syntax elements that enable the decoder to determine decoding information in a manner corresponding to that used by an encoder.

At least one embodiment comprises creating and/or transmitting and/or receiving and/or decoding a bitstream or signal that includes one or more of the described syntax elements, or variations thereof.

At least one embodiment comprises a TV, set-top box, cell phone, tablet, or other electronic device that performs transform method(s) according to any of the embodiments described.

At least one embodiment comprises a TV, set-top box, cell phone, tablet, or other electronic device that performs transform method(s) determination according to any of the embodiments described, and that displays (e.g., using a monitor, screen, or other type of display) a resulting image.

At least one embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

At least one embodiment comprises a TV, set-top box, cell phone, tablet, or other electronic device that receives (e.g., using an antenna) a signal over the air that includes an encoded image, and performs transform method(s).

1. A method, comprising:
partitioning at least a portion of a video image into patches,
determining at least one head network, wherein a head network is a neural representation containing most weights, from global information comprising training results over a plurality of the patches of the at least portion of the video image;
determining a plurality of tail networks from said patches of the at least portion of the video image, wherein a tail network is a network designed to adapt the head network to a particular image patch;
determining weights corresponding to the head network;
determining weights corresponding to the plurality of tail networks by minimizing a cost function associated with an implicit neural representation of said patches through learning weights of the at least one head network; and;
encoding said weights of the plurality of tail networks into video data.

2. An apparatus, comprising:
memory, and
a processor, configured to perform:
partitioning at least a portion of a video image into patches;
determining at least one head network, wherein a head network is a neural representation containing most weights, from global information comprising training results over a plurality of the patches of the at least portion of the video image;
determining a plurality of tail networks from said patches of the at least portion of the video image, wherein a tail network is a network designed to adapt the head network to a particular image patch;
determining weights corresponding to the head network;
determining weights corresponding to the plurality of tail networks by minimizing a cost function associated with an implicit neural representation of said patches through learning weights of the at least one head network; and;
encoding said weights of the plurality of tail networks into video data.

3. A method, comprising:
parsing video data for weights of a tail network, wherein a tail network is a network designed to adapt a head network to a particular image patch, for a patch of video data;
reconstructing the patch of video data using said weights along with an optimized head network.

4. An apparatus, comprising:
memory, and
a processor, configured to perform:
parsing video data for weights of a tail network, wherein a tail network is a network designed to adapt a head network to a particular image patch, for a patch of video data;
reconstructing the patch of video data using said weights along with an optimized head network.

5. The method of claim 1, wherein said head network and said plurality of tail networks are part of a neural network.

6. The method of claim 1 wherein minimization of a loss function of an implicit neural representations is used.

7. The method of claim 1, wherein said portion of video data is part of a sequence of frames.

8. The apparatus of claim 2, wherein said head network is common to all images.

9. The apparatus of claim 2, wherein said head network is independent of said video image.

10. The apparatus of claim 2, wherein said head network is learned on a first frame of a sequence of video data and used for subsequent video data.

11. A device comprising:
an apparatus according to claim 4; and
at least one of (i) an antenna configured to receive a signal, the signal including a video block, (ii) a band limiter configured to limit the received signal to a band of frequencies that includes the video block, and (iii) a display configured to display an output representative of a video block.

12. A non-transitory computer readable medium containing data content generated according to the method of claim 1, for playback using a processor.

13. (canceled)

14. A computer program product comprising instructions which, when the program is executed by a computer, cause the computer to carry out the method of claim 3.

15. A non-transitory computer readable medium containing data content comprising instructions to perform the method of claim 3.

16. The method of claim 3, wherein said dead network and said plurality of tail networks are part of a neural network.

17. The method of claim 3, wherein minimization of a loss function of an implicit neural representations is used.

18. The method of claim 3, wherein said portion of video data is part of a sequence of frames.

19. The apparatus of claim 4, wherein said head network is common to all images.

20. The apparatus of claim 4, wherein said head network is independent of said video image.

21. The apparatus of claim 4, wherein said head network is learned on a first frame of a sequence of video data and used for subsequent video data.
